(19) United States
(12) Patent Application Publication
(10) Pub. No.: US 2012/0185378 A1
(43) Pub. Date: Jul. 19, 2012

(54) System and Method for Adaptive Selection of Bank Card for Payment

(75) Inventor: Zhongsheng Liu, Hangzhou (CN)

(73) Assignee: ALIBABA GROUP HOLDING LIMITED, Grand Cayman (unknown)

(21) Appl. No.: 12/812,691

(22) PCT Filed: Apr. 28, 2010
(86) PCT No.: PCT/US10/32810

§ 371 Date: Jul. 13, 2010

(30) Foreign Application Priority Data
Jul. 3, 2009 (CN) 200910159419.0

(51) Int. Cl. G06Q 20/34

(52) U.S. Cl. 705/39

(57) ABSTRACT

A system, that adaptively selects a bank card for payment, performs payment operations between a user and a payee through a payment platform. The payment platform includes a database, a rule engine unit, and a payment processing unit. The database stores information including: account information of a user, information of a plurality of bank cards that are used for payment, card selection rules, and payment records. The rule engine unit selects a bank card for the present payment from the plurality of bank cards based on the information of card selection rules. The payment processing unit receives a payment request from a user client, obtains the bank card for the present payment from the rule engine unit, and transfers a payment amount to the payee using the selected bank card. The present disclosure allows setting up card selection rules in advance. Therefore, in each card selection, subsequent payment operations may be continued without the need for a user to wait until interaction associated with card selection has been established with a user client and a card has been selected by the user. The speed of payment can be improved, and the resources of the network and the payment platform will not be occupied.

### CROSS REFERENCE TO RELATED PATENT APPLICATIONS

This application is a national stage application of an international patent application PCT/US10/32810, filed Apr. 28, 2010, which claims priority from Chinese Patent Application No. 200910159419.0, filed Jul. 3, 2009, entitled “System and Method for Adaptive Selection of Bank Card for Payment,” which applications are hereby incorporated in their entirety by reference.

### TECHNICAL FIELD

The present disclosure is directed to networking technologies, and particularly to a system for adaptive selection of a bank card for payment and a method thereof.

### BACKGROUND

In the past few years, electronic commerce has gradually become the primary trend of economic development on the Internet. Online shopping and online payment have become a convenient style of living.

FIG. 1 shows a schematic structural diagram illustrating an environment 100 of online payment under existing technology. User client 11A of a user makes a payment to a payee through a payment platform 12. The payee may be a merchant. Payee client 13 of the payee may connect with the payment platform 12 through a network. The user may have a payment account on the payment platform 12 and may have opened a bank account on a bank subsystem 14. In order to reduce risk, the user generally does not input the bank card number and the password directly onto the web page to make the payment. A financial loss could easily be incurred by the user if the card number and the password were leaked out.

As such, payment platform 12 may correlate a payment account with a bank account. The user only needs to select a bank card that has been correlated, while payment platform 12 will be responsible for completing such data operations as account settlement and account reconciliation with bank subsystem 14. In order to improve security, payment platform 12 may further allow the user to set up an alias of the bank card. When submitting a payment request to payment platform 12, user client 11 further submits information such as the alias of a designated bank card in addition to the payment information (which includes information of the payee and the payment amount). Payment platform 12 processes the payment request and transfers the payment amount to an account of the payee. The account may be a payee account of the payee on payment platform 12 or a bank account of the payee in a bank.

Payment platform 12 includes at least payment server 21, account reconciliation server 22 and database 23. Database 23 stores information of users who use payment platform 12, information of associated accounts, information regarding payment processing, and information related to account settlement and account reconciliation with various bank subsystem 14. Payment server 12 is primarily used for completing operations of processing payment requests. Account reconciliation server 22 is primarily used for completing operations such as account settlement, account reconciliation and data exchange with bank subsystem 14.

Nowadays, a user may set up information of multiple bank cards that may be used for payment in payment platform 12. When user clients 11A or 11B connects with payment platform 12 through the Internet, and sends to payment platform 12 a payment request which does not carry any information of a bank card for the current payment, payment platform 12 needs to obtain information of the bank card for the current payment by interacting with the user client 11A or 11B. Bank card information is sensitive information. Therefore, not only will this approach occupy processing resources of payment server 21, but the security of exchanges of this kind of sensitive information over the Internet is also low. Furthermore, the user is queried as to which bank card to be used each time, thus prolonging the processing time of the payment and occupying resources of payment server 21 and the network.

With existing technology, when a payment is made by telephone or through WAP (i.e., Wireless Application Protocol) and if associated payment request which is sent to payment platform 12 does not carry any information of a bank card that is used in the current payment, payment platform 12 may not be able to provide an interactive web page to allow selection of the bank card by the user due to resource limitations. Generally, payment platform 12 will then select a bank card that is used most frequently by the user to complete the payment. If payment platform 12 is able to provide an interactive web page for selection of a bank card by the user, payment platform 12 may provide the interactive web page to the mobile phone user through WAP network and establish interaction with the mobile phone user. Each interaction associated with card selection requires communication with a web server, WAP proxy server and a wireless communication network. The time duration for selecting a card therefore becomes longer, leading to a longer processing time for associated payment. Furthermore, if an error has occurred in one of the associated devices, the entire card selection process would be terminated, thus reducing the success rate of making a payment.

The existing payment process of making a payment through a payment platform normally requires the payment platform to provide an interactive web page to a user for selecting a specific bank card to complete the payment. This kind of method will not only occupy network resources, but most importantly also reduce the speed of payment processing, requiring payment server 21 to spend resources and time to complete related processing operations. Moreover, in certain application scenarios, payment platform 12 may not be able to provide an interactive web page to the user for selecting a specific bank card. Furthermore, a security issue may exist in the self-assertion of payment platform 12 in selecting a certain bank card.

### SUMMARY

A goal of the present disclosure is to provide a system for adaptive selection of a bank card for payment in order to solve the technical problems of low security, prolonged payment processing time and resource occupancy in the existing card selection process.

Another goal of the present disclosure is to provide a method for adaptive selection of a bank card for payment in order to solve the technical problems of low security, prolonged payment processing time and resource occupancy in the existing card selection process.

In one aspect, a system that adaptively selects a bank card for payment performs payment operations between a user and a payee through a payment platform. The payment platform includes:

a database, that stores information including account information of a user, a plurality of bank cards that are used for payment, card selection rules, and payment records;

a rule engine unit, communicatively coupled to the database, that selects a bank card for the present payment based on the card selection rules; and

a payment processing unit, communicatively coupled to the database and the rule engine unit, that receives a payment request from a user client, obtains the bank card for the present payment from the rule engine unit, and transfers a payment amount to the payee using the bank card.

The rule engine unit and the payment processing unit may be respectively installed in a rule engine server and a payment server.

A method that adaptively selects a bank card for payment and performs payment operations between a user and a payee through a payment platform includes:

(1) set up card selection rules related to selecting a payment card from a plurality of bank cards;

(2) upon receiving a payment request from a user client of a user, select a bank card for the present payment from the plurality of bank cards based on the card selection rules and payment records of the user; and

(3) transfer a payment amount to the payee using the bank card.

Compared with existing technologies, the disclosed system and method have the following advantages:

First, the disclosed system and method allow card selection rules to be established in advance. Therefore, the subsequent payment operations may be continued without the need to wait until interaction associated with card selection has been established with a user client and a card has been selected by the user. Not only will the speed of payment be improved, but also the resources of the network and the payment platform will not be occupied. In particular, when the user uses a mobile phone to initiate a payment request to the payment platform through WAP protocol, no further operation of card selection is required. Therefore, efficiency of the entire payment process is increased, and the success rate of making a payment is further improved.

Second, operations of making a payment and selecting a card are accomplished separately through installation of the payment server and the rule engine server. Therefore, no substantial modification is required in existing payment servers. With the introduction of an additional rule engine server for completing the card selection operation, the design can improve the security of the existing payment server and the coupling of the system.

Finally, each time the rule engine software starts, the card selection rules are imported into the memory of the server in advance. Moreover, the card selection rules stored within the memory are regularly updated. Therefore, the speed of card selection is improved with the accuracy of card selection being guaranteed at the same time.

### DESCRIPTION OF DRAWINGS

FIG. 1 shows a schematic structural diagram illustrating an environment 100 of online payment under existing technology.

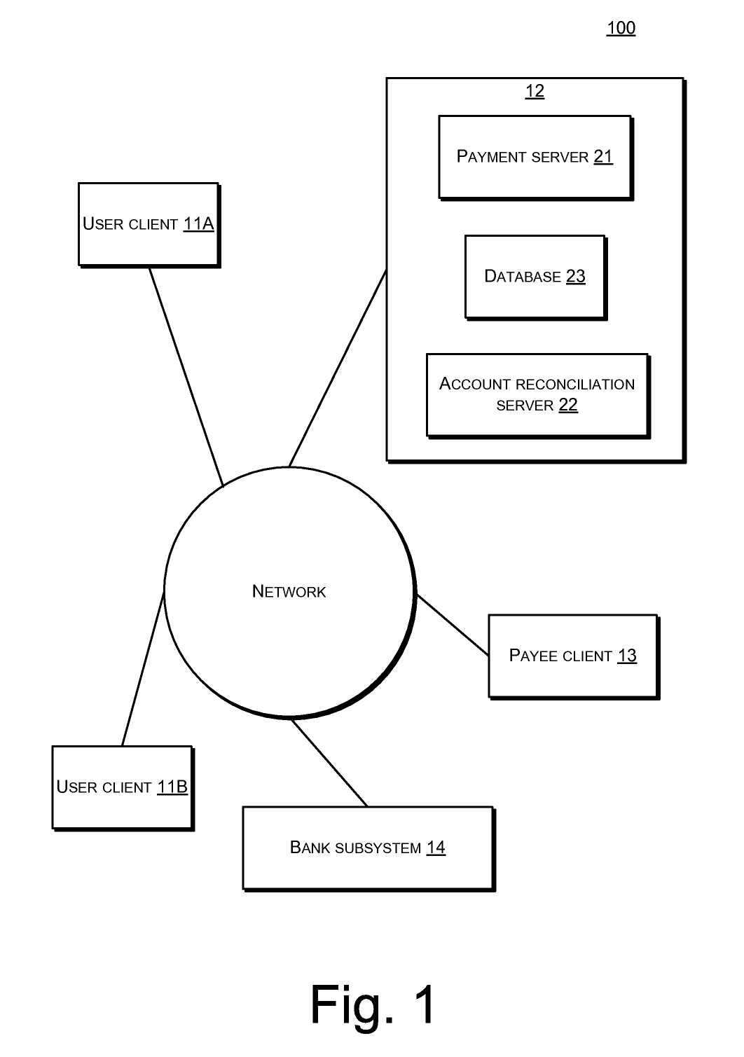

FIG. 2 shows a schematic structural diagram illustrating a system 200 for adaptive selection of a bank card for payment in accordance with the present disclosure.

FIG. 3 shows a schematic structural diagram illustrating components of a payment platform 300 in accordance with the present disclosure.

FIG. 4 shows a flow chart illustrating a method 400 for adaptive selection of a bank card for payment in accordance with the present disclosure.

FIG. 5 shows a schematic structural diagram illustrating a system 500 for adaptive selection of a bank card for payment in accordance with the present disclosure.

FIG. 6 shows a schematic structural diagram illustrating components of a payment platform 600 in accordance with the present disclosure.

FIG. 7 shows a flow chart illustrating a method 700 for adaptive selection of a bank card for payment in accordance with the present disclosure.

### DETAILED DESCRIPTION

The present disclosure is described in details using the accompanying figures.

### First Exemplary Embodiment

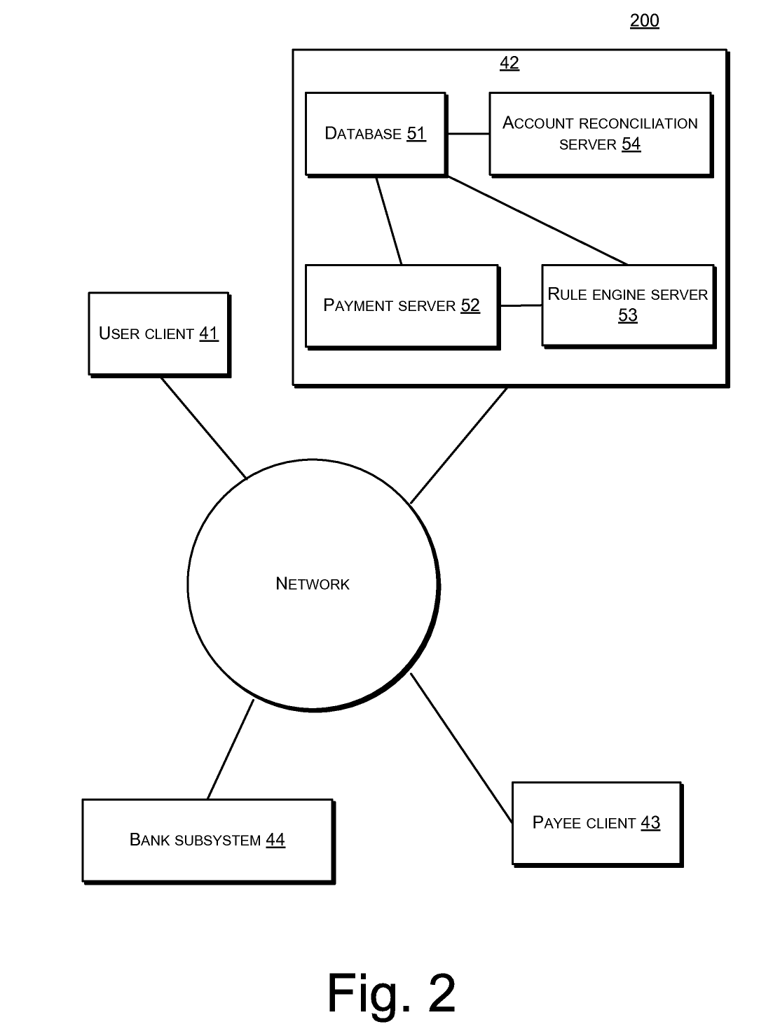

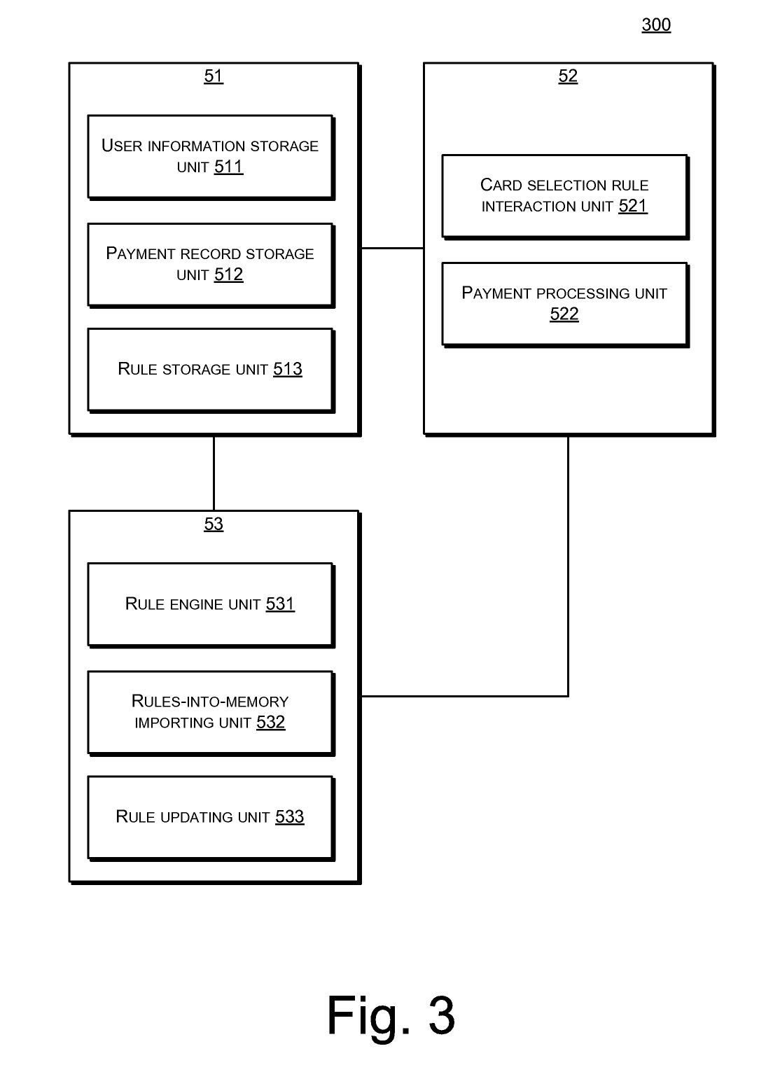

FIG. 2 and FIG. 3 show schematic diagrams illustrating a first exemplary system 200 for adaptive selection of a bank card for payment in accordance with the present disclosure. The system 200 includes user client 41, payment platform 42, payee client 42, and various bank subsystems 44. User client 41 may be a network client which connects with payment platform 42 through the Internet, telephone equipment which communicates with payment platform 42 through an existing fixed line system, or a mobile phone which uses WAP protocol to establish communication with payment platform 42 through a wireless communication network and the Internet. The payee sets up an account on payment platform 42, or a payee account on a bank subsystem which is connected with payment platform 42. In the present exemplary embodiment, the payee has set up a payee account on payment platform 42 while the user has set up a payment account on payment platform 42. In practice, the payee account set up by the payee and the payment account set up by the user are regarded as user accounts to be uniformly managed by payment platform 42. Specifically, the payee and the user are both users of payment platform 42. The payee account and the user payment account are merely different terms. In nature, they are user accounts to be managed.

Payment platform 42 may include database 51, payment server 52, rule engine server 53 and account reconciliation server 54.

Database 51 stores account information of the users. The user stores in the database 51 information that includes information of a plurality of bank cards that may be used for payment, information regarding card selection rules, and payment records. FIG. 3 shows a schematic structural diagram of database 51, which includes:

a user information storage unit 511 that stores information of the user as well as information of a corresponding payment account, information of the plurality of bank cards that may be used for payment and that have been paired with the payment account;

a payment record storage unit 512 that stores information of each result associated with the processing of each payment request;

a rule storage unit 513 that stores card selection rules of the plurality of bank cards set up by the user and card selection rules of the system including payment limits of various bank cards.

Generally, the user information storage unit 511 and the payment record storage unit 512 may be separate functions from a logic perspective, but may be physically implemented in one embodiment through a wide table to store all the information. For example, the wide table may regard a payment account as a unit of storage, with associated fields including an access password corresponding to the account, a payment password, user information, information of a plurality of bank cards and payment information, etc. The information of the plurality of bank cards may include: bank card numbers, alias names, information of the banks to which respective bank cards belong, transaction amounts of respective bank cards on a current day, and respective total transaction amounts in a current month, etc. Payment information may include the transaction amount of a corresponding user account on current day and the total transaction amount in a current month. Payment server 52 may update the contents of this wide table on a regular basis.

In one embodiment, rule storage unit 513 may include a system card selection rule storage subunit, user card selection rule storage subunit, and rule storage subunit. The system card selection rule storage subunit may store card selection rules of the system including payment limits of various bank cards. The card selection rules refer to restriction requirements related to usage of various bank cards and are primarily restriction requirements for payment limits of various bank cards. In one embodiment, the system card selection rule storage subunit may be implemented in the form of a table to store the card selection rules. For example, various bank cards may be regarded as units to store the restriction requirements for usage of respective bank cards. The user card selection rule storage subunit stores card selection rules defined by the user. In one embodiment, the card selection rules may be card selection rules separately stored for each bank card. In another embodiment, one or more card selection rules may be set up for all the cards. The rule storage subunit may determine resulting card selection rules of the user upon merging the card selection rules defined by the user and the card selection rules of the system. In one embodiment, the user card selection rule storage subunit may be optional and hence omitted. Upon receiving the card selection rules defined by the user, the system card selection rule storage subunit may be directly accessed to determine the resulting card selection rules of the user, which are then stored in the rule storage subunit.

For example, the user-defined rules that are received by payment platform 42 may be payment rules of a bank credit card which include: (1) a single transaction amount to be less than eight hundred dollars; (2) daily total amount limit to be two thousand dollars; (3) monthly total amount to be less than two thousand dollars; and (4) period of use to be between the fifteenth day and the thirty-first day of each month. The card selection rules for this bank credit card that are stored in the system card selection rule storage subunit may include: (1) a single transaction amount to be less than five hundred dollars; (2) daily total amount limit to be one thousand and five hundred dollars; (3) monthly total amount limit to be less than two thousand dollars; and (4) period of use to be between fifteenth and thirty-first of each month. Specifically, these four restriction requirements are stored in the card selection rules and may be stored in the form of Table 1 for example.

TABLE 1

| User | Bank | | Card's | Single Transaction | Daily Total | Monthly Total | Period |
|---|---|---|---|---|---|---|---|
| ID | Name | Card Type | Alias Name | Amount Limit | Amount Limit | Amount Limit | of Use |
| 001 | GDB | Credit Card | Pay Card | 500 | 1500 | 2000 | 15-31 |
| 001 | . . . | . . . | . . . | . . . | . . . | . . . | . . . |

The various storage units described in the above database 51 are primarily divided from a logical point of view but not from a physical point of view. Physically, database 51 may be made up of a plurality of databases or may be a single database.

Rule engine server 53 may connect with database 51 and select a bank card for the current payment from the plurality of bank cards based on the card selection rules. In the present embodiment, rule engine software (which is abbreviated as rule engine unit 531 herein) is set up in advance to complete card selection operations. Rule engine unit 531 may be implemented using open source Drools in one embodiment, or may be implemented using a self-constructed DFA in another embodiment. The present embodiment has no limitations on which programming language will be used for implementing rule engine unit 531. Rule engine unit 531 is primarily used for accessing records in the wide table to determine which bank card(s) satisfy/satisfies the stored restriction requirements of the various bank cards in Table 1. Rule engine unit 531 regards a bank card as a unit and determines whether the bank card satisfies the requirements in Table 1 by accessing the records in the wide table. If affirmative, the bank card will be rendered for the current payment. If not, another bank card is selected and checked whether it satisfies the restrictions in Table 1. This process continues until a bank card that satisfies the requirements is found for the current payment or until all bank cards have been found not to satisfy the requirements. In one embodiment, rule engine unit 531 may select all bank cards that satisfy the requirements in Table 1 and then determine a bank card for the current payment according to a predetermined order of selection. In general, rule engine unit 531 may be implemented using software. However, the present disclosure does not exclude the possibility of using hardware for implementation. Rule engine unit 531 in the present disclosure is primarily referred to as a processor that has installed thereon rule engine software.

Besides rule engine unit 531, rule engine server 53 may further include:

a rules-into-memory importing unit 522, that imports the information of card selection rules into a memory of the server each time when the rule engine software starts; and

a rule updating unit 533, that obtains new or updated card selection rules from database 51 and, based on these card selection rules, updates the card selection rules that are currently stored in the memory.

In one embodiment, rule updating unit 533 may regularly check with database 51 to obtain new or updated card selection rules. A relatively common implementation may be to set up a field of updated time in Table 1, which is used for storing the time at which the card selection rules of a bank card are updated. Based on this field of updated time, rule updating unit 533 can obtain new or updated card selection rules.

Rule engine unit 531, rules-into-memory importing unit 532 and rule updating unit 533 are primarily divided from a logical perspective. However, the present disclosure is not limited to this type of division. In a practical implementation, all functions of rule engine unit 531, rules-into-memory importing unit 532 and rule updating unit 533 may be implemented using software.

Payment server 52 may include card selection rule interaction unit 521 and payment processing unit 522. In one embodiment, payment server 52 may further include the following functions: receiving a new account of the user, modifying information of the user and associated accounts, and displaying payment information of the user, etc. As these functions already exist in existing payment servers, no further description will be given in the present disclosure. Different from existing payment servers are card selection rule interaction unit 521 and payment processing unit 522 of payment server 52 disclosed herein.

Card selection rule interaction unit 521 receives new or modified card selection rules of the user and stores the card selection rules into the database.

Payment processing unit 522 receives a payment request from user client 41, obtains a bank card for the current payment through rule engine unit 531, and transfers a payment amount to the payee using the bank card. Upon receiving the payment request from user client 41, the payment processing unit 522 parses out the user information, the payee information, and the required payment amount. When corresponding bank card information is found in the wide table according to the user information and when information of multiple bank cards is found, payment processing unit 522 submits a card selection request to rule engine server 53 and receives a card selection processing result from rule engine server 53. The card selection processing result may include two types: a certain card is selected to be the bank card for the current payment, and no bank card that satisfies the requirements is found.

If a certain card is selected to be the bank card for the current payment, the associated payment is completed using the bank card and a payment processing result is stored in database 51. If no bank card that satisfies the requirements is found, the process is terminated and the corresponding processing result is returned to user client 41.

Account reconciliation server 54 completes account reconciliation with the various banks based on the information of the processing results of each payment request that is stored in payment record storage unit 512.

In one embodiment, account reconciliation server 54 and payment server 52 may be realized by a single server.

In the present embodiment, operations of making a payment and selecting a card are accomplished separately by payment server 52 and rule engine server 53. Therefore, no substantial modification is required in existing payment servers. With the introduction of an additional rule engine server 53 for completing card selection operation, the design can improve the security of an existing payment server and the coupling of the system.

In the present embodiment, each time the rule engine software starts, the information of card selection rules are imported into the memory of server 53 in advance. Moreover, the card selection rules stored within the memory are regularly updated. Therefore, the speed of card selection is improved with the accuracy of card selection being guaranteed at the same time.

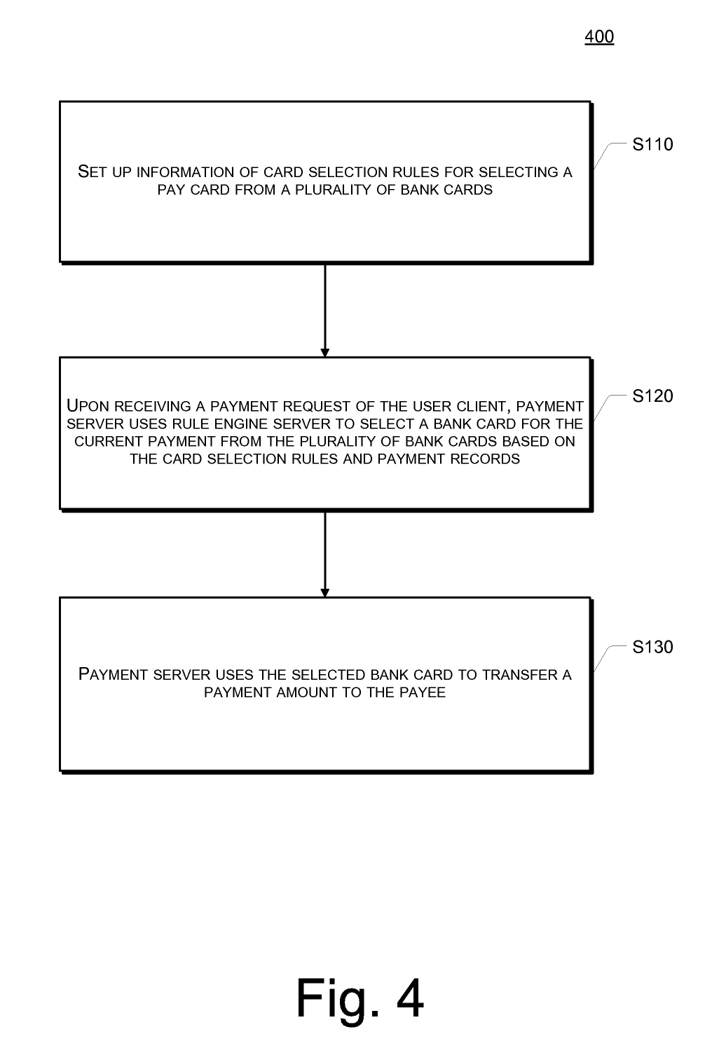

FIG. 4 shows a flow chart of a method 400 for adaptive selection of a bank card in accordance with the present exemplary embodiment. The method conducts payment operations between a user and a payee through the payment platform, and includes:

S110: Information of card selection rules for selecting a pay card from a plurality of bank cards is set up.

First, payment server 52 provides to the user a maintenance interface for setting or modifying bank card selection rules.

Payment server 52 subsequently receives the user-defined card selection rules that have been set or modified through the maintenance interface.

Finally, payment server 52 merges the user-defined card selection rules and system card selection rules, which include payment limits of various bank cards, together into card selection rules of the present user which are then stored into rule storage unit 513 (such as Table 1) of the database.

S120: Upon receiving a payment request of the user client, payment server 52 uses rule engine server 53 to select a bank card for the current payment from the plurality of bank cards based on the card selection rules and payment records.

Upon receiving the payment request of the user client, payment server 52 obtains information of the required payment amount and information of the payee client.

If the user is found to have multiple bank cards, payment server 52 submits a card selection request to rule engine server 53.

Among the multiple bank cards, rule engine server 53 determines which bank card(s) satisfy/satisfies the requirements of the card selection rules one by one, and selects one bank card that satisfies the requirements of the card selection rules to be the bank card for the current payment.

S130: Payment server 52 uses the selected bank card to transfer a payment amount to the payee.

Payment server 52 stores the associated payment processing condition in the payment records and completes the operations of account reconciliation and account settlement with bank subsystems through account reconciliation server 54.

In the present embodiment, each time the rule engine software starts, the card selection rules are imported into the memory of the server 53. Moreover, new or updated card selection rules are regularly obtained from the database. Based on these card selection rules, existing card selection rules that are currently stored in the memory are updated. Therefore, the speed of card selection is improved while the accuracy of card selection is guaranteed at the same time.

### Second Exemplary Embodiment

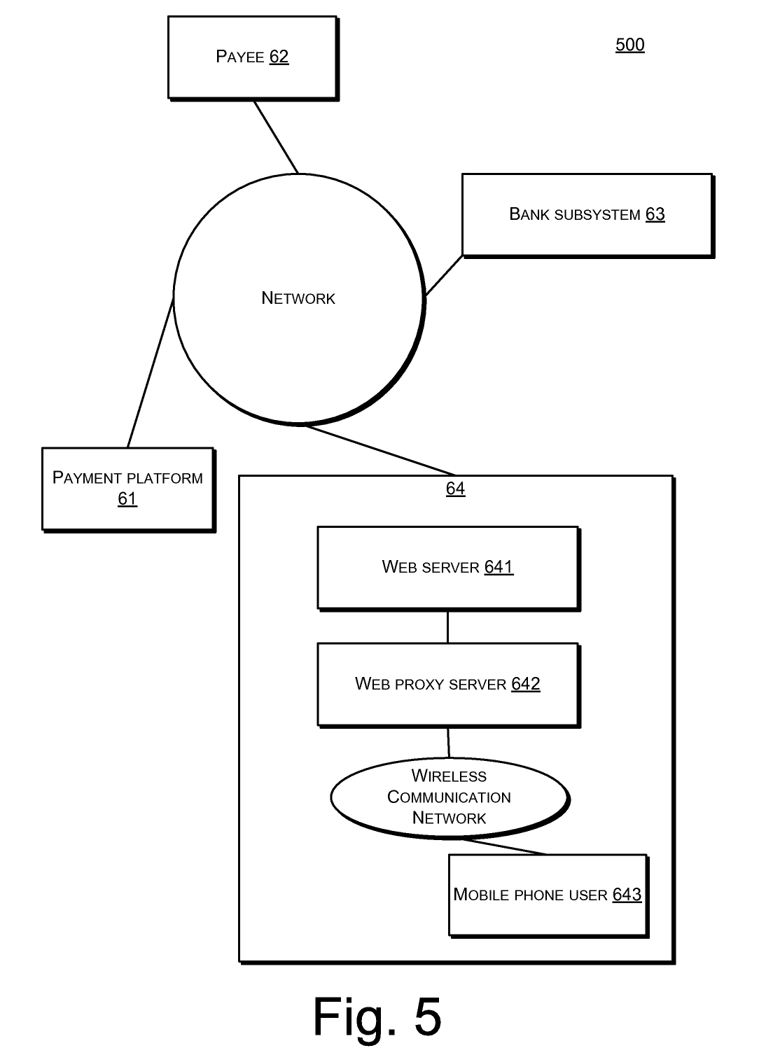

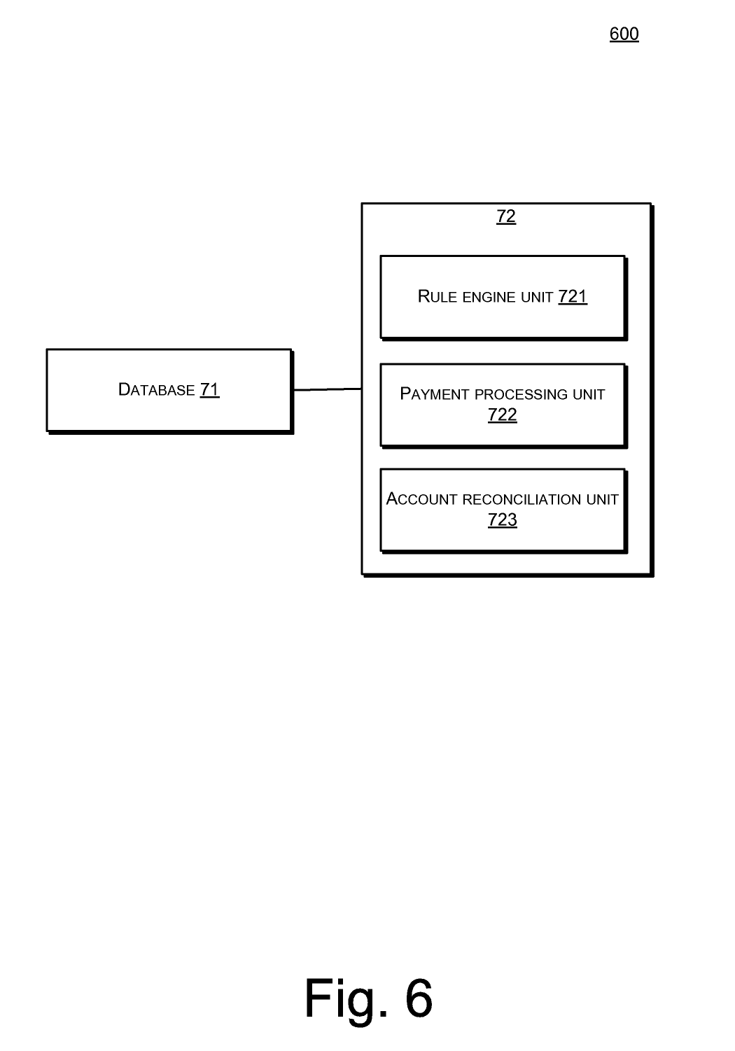

FIG. 5 and FIG. 6 show schematic diagrams illustrating a second exemplary system 500 for adaptive selection of a bank card for payment in accordance with the present disclosure. The system includes payment platform 61, payee client 62, various bank subsystems 63, and WAP network 64. WAP network 64 includes web server 641, WAP proxy server 642 and mobile phone terminal 643. Web server 641 transmits data in the form of a HTML web page. The HTML filter of web server 641 converts this web page into WML (i.e., Wireless Markup Language) format, which is subsequently processed to become binary WML data and sent to the user client (i.e., mobile phone terminal 643) by WAP proxy server 642. WAP network 64 may be of another form. Since these components are employed in existing technologies, details are not repeatedly described herein. In the present embodiment, web server 641, WAP proxy server 642 and mobile phone terminal 643 are merely used for illustrative purpose. The present disclosure is not limited thereto.

Referring to FIG. 6, payment platform 61 may further include database 71 and server 72. Data stored in database 71 may be of the same type as that in the first exemplary embodiment. In one embodiment, server 72 may include rule engine unit 721, payment processing unit 722, and account reconciliation unit 723.

Rule engine unit 721, communicatively coupled to database 71, that selects a bank card for the current payment from the plurality of bank cards based on information of card selection rules.

Payment processing unit 722, communicatively coupled to database 71 and rule engine unit 721, receives a payment request from a user client, obtains the bank card for the present payment from rule engine unit 721, and transfers a payment amount to the payee using the bank card.

Account reconciliation unit 723 completes the operations of account reconciliation and account settlement with the various bank subsystems.

In one embodiment, the functions of the payment server, rule engine server and account reconciliation server in the first exemplary embodiment are realized by server 72. This implementation can improve the processing speeds of selecting a card and making a payment.

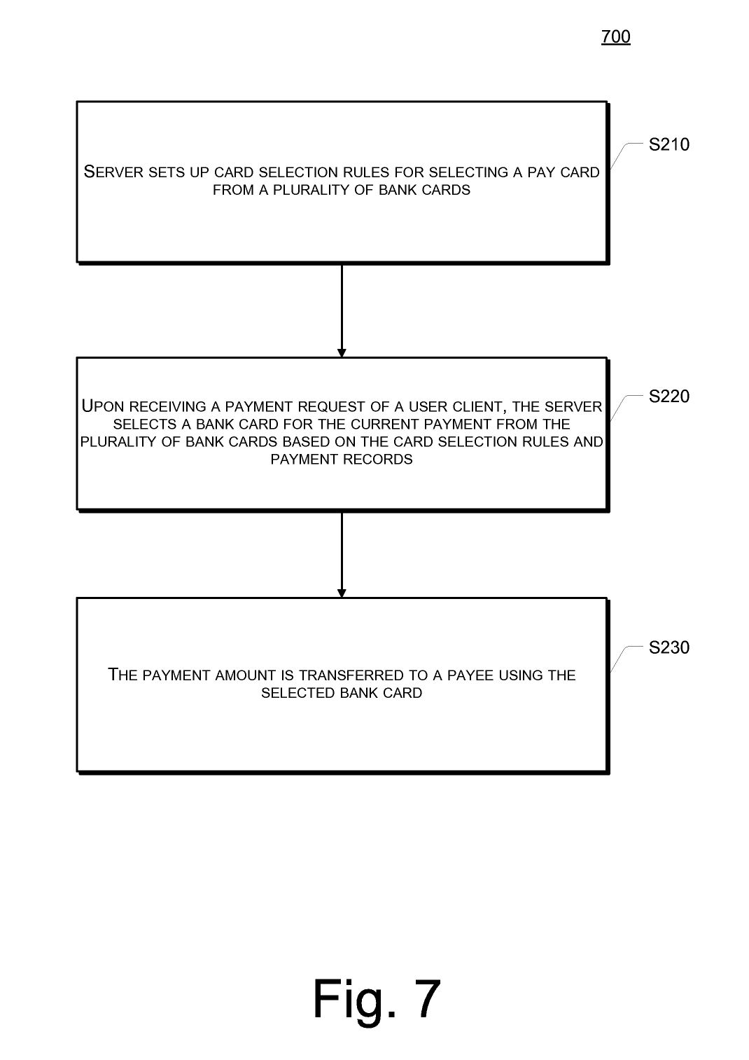

FIG. 7 shows a flow chart of a method 700 for adaptive selection of a bank card in accordance with the second exemplary embodiment. The method conducts payment operations between a user and a payee through the payment platform, and includes:

S210: The server sets up card selection rules for selecting a pay card from a plurality of bank cards.

The user may set up information related to card selection rules for a pay card using a networking client, or set up information related to card selection rules for a pay card using mobile phone terminal 643.

Basically, the process of card selection may include the following: the server provides to the user a maintenance interface for setting or modifying bank card selection rules; the server subsequently receives the user-defined card selection rules that have been set or modified through the maintenance interface; the server merges the user-defined card selection rules and system card selection rules which include payment limits of various bank cards together into card selection rules, which are then stored into the database.

S220: Upon receiving a payment request of the user client, the server selects a bank card for the current payment from the plurality of bank cards based on the card selection rules and payment records.

Upon receiving the payment request of the user client, the server obtains information of the required payment amount and information of the payee client. If the user is found to have multiple bank cards, the server submits a card selection request to the rule engine unit. Among the multiple bank cards, the rule engine unit determines which bank card(s) satisfy/satisfies the requirements of the card selection rules one by one, and selects one bank card that satisfies the requirements of the card selection rules for the current payment.

S230: The payment amount is transferred to the payee using the selected bank card.

The server uses the bank card to complete the payment operations and subsequently completes the operations of account reconciliation and account settlement with the various bank subsystems on a regular basis.

In the present embodiment, the card selection rules may be stored in a memory or database. Furthermore, the server may regularly obtain new or updated card selection rules from the database and, based on these new or updated card selection rules, update existing card selection rules that are currently stored in the memory.

What is claimed is:

1. A payment platform system for adaptive selection of a bank card for payment, wherein payment operations between a user and a payee are conducted through the payment platform system, the payment platform system comprising:
a database, that stores information including account information of the user, information of a plurality of bank cards that are used for payment, information of card selection rules, and information of payment records;
a rule engine unit, communicatively coupled to the database, that selects a bank card for the present payment from the plurality of bank cards based on the information of card selection rules; and
a payment processing unit, communicatively coupled to the database and the rule engine unit, that receives a payment request from a user client of the user, obtains the bank card for the present payment from the rule engine unit, and transfers a payment amount to the payee using the selected bank card.

2. The payment platform system of claim 1, wherein the rule engine unit is incorporated in a rule engine server and the payment processing unit is incorporated in a payment server.

3. The payment platform system of claim 2, wherein the rule engine server further comprises: a rules-into-memory importing unit, that imports the information of card selection rules into a memory of the rule engine server each time the rule engine server starts.

4. The payment platform system of claim 3, wherein the rule engine server further comprises:
a rule updating unit, that obtains new or updated card selection rules from the database and updates the card selection rules that are currently stored in the memory based on the card selection rules.

5. The payment platform system of claim 1, wherein the database comprises:
a user information storage unit, that stores information comprising information of the user, information of a corresponding payment account, information of the plurality of bank cards that may be used for payment and that have been paired with the payment account;
a rule storage unit, that stores card selection rules with respect to the plurality of bank cards set up by the user and card selection rules of the system comprising payment limits of the bank cards; and
a payment record storage unit, that stores information of each processing result associated with the processing of each payment request.

6. The payment platform system of claim 5, further comprising:
a card selection rule interaction unit, that receives new or modified card selection rules with respect to the user and stores the received card selection rules into the database.

7. The payment platform system of claim 6, wherein the rule storage unit is stored in the database in a form of a table.

8. A method of adaptive selection of a bank card for payment, wherein payment operations between a user and a payee are conducted through a payment platform, the method comprising:
setting up card selection rules related to selecting a payment card from a plurality of bank cards;
upon receiving a payment request from a user client of the user, selecting a bank card for a current payment from the plurality of bank cards based on the card selection rules and payment records of the user; and
transferring a payment amount to the payee using the selected bank card.

9. The method of claim 8, wherein setting up card selection rules related to selecting a payment card from a plurality of bank cards further comprises:
receiving user-defined card selection rules that have been set or modified; and
merging the card selection rules that have been defined by the user and system card selection rules which comprise payment limits of the bank cards into resulting card selection rules.

10. The method of claim 9, further comprising:
storing the resulting card selection rules into a database.

11. The method of claim 10, further comprising:
obtaining new or updated card selection rules; and
updating the card selection rules that are currently stored in the database.

12. The method of claim 8, further comprising:
setting up an operation for processing card selection in a rule engine server and an operation for processing payment request in a payment server.

13. The method of claim 12, wherein selecting a bank card for a current payment from the plurality of bank cards based on the card selection rules and payment records of the user further comprises:
obtaining information, by the payment server, of a required payment amount and information of a payee client upon receiving the payment request;
submitting a card selection request to the rule engine server when the payment server determines that the user has multiple bank cards;
determining, by the rule engine server, whether each of the multiple bank cards satisfies the card selection rules; and
selecting a bank card that satisfies requirements of the card selection rules to be the bank card for the current payment.

14. The method of claim 13, wherein transferring a payment amount to the payee using the selected bank card further comprises:
storing payment processing condition in the payment records; and
completing operations of account reconciliation and account settlement with pertinent bank subsystems.
